(19) United States
(12) Patent Application Publication
(10) Pub. No.: US 2010/0175514 A1
(43) Pub. Date: Jul. 15, 2010

(54) Retractable Wrench

(76) Inventor: Chih-Ching Hsieh, Fongyuan City (TW)

Correspondence Address: BRIAN M. MCINNIS, 12th Floor, Ruttonjee House, 11 Duddell Street, Hong Kong, HK

(21) Appl. No.: 12/353,829

(22) Filed: Jan. 14, 2009

(51) Int. Cl. B25B 23/16

(52) U.S. Cl. 81/177.2

(57) ABSTRACT

This specification discloses a retractable wrench comprising a first driver, a second driver, and a positioning component. The first driver has a driving part on its one end and a mounting part on its other end. The mounting part has an opening with an accommodating space facing the driving part. The second driver has a connecting handle on the end corresponding to the opening end of the mounting part of the first driver. The connecting handle connects to and slides in the accommodating space of the first driver. The other end is provided with another driving part. The driving parts of the drivers are disposed in opposite directions. The positioning component is interposed between the mounting part of the first driver and the connecting handle of the second driver for their connection and positioning.

### BACKGROUND OF THE INVENTION

1. Field of Invention

The invention relates to a retractable wrench structure and, in particular, to a retractable wrench structure that consists of two drivers that slide against each other and has simple components.

2. Related Art

FIG. 9 shows a conventional wrench structure consisting of a holder 5 and two drivers 6. The holder 5 has an accommodating space 51 going through both ends of the holder 5 for the drivers 6 to slide in each of the connecting holders 61.

The connecting holder 61 of each of the drivers 6 is formed with a track 62. The inner wall of each of the tracks 62 is formed with several positioning nodes 63 in equal space. After each of the drivers 6 slides into the accommodating space 51 of the holder 5, a positioning element 52 goes through a screw hole 53 on the holder 5 and the positioning node 63 of the driver 6, thereby positioning the corresponding driver 6 in the accommodating space 51 of the holder 5.

Please refer to FIG. 10 for another conventional wrench structure. A through hole 64 is formed at an appropriate position of each of the drivers 6 for accommodating two steel balls 65 and a spring 66. Each of the steel balls 65 is urged by the spring 66 against the inner wall surface of the accommodating space 51.

However, the above-mentioned conventional wrenches have the drawbacks that they have complicated components and thus higher production costs and that the connecting holder is weaker in strength because a track is formed thereon. Therefore, it is necessary to improve the conventional wrenches.

### SUMMARY OF THE INVENTION

An objective of the invention is to provide a retractable wrench to solve the problems existing in the prior art. The invention comprises two drivers. The connecting holder of one of the drivers has an accommodating space for the connecting holder of the other driver to slide therein. A positioning component is used to position the two drivers. The entire structure is greatly simplified and thus involves less production cost. The connecting holders also have good strength for the safety of the user.

According to one embodiment of the invention, the positioning component consists of a positioning part and a fixing part. The shape and structure of the positioning component can be a locking structure that is concave or convex or has steel balls and a spring. Such a structure can achieve the function of easy adjustment in the length of the wrench.

According to another embodiment of the invention, each of the drivers comprises a driving part and a connecting holder connected pivotally with each other. Therefore, the driving part in the invention can pivotally swing for the user to use in different environments.

To achieve the above-mentioned objective, the invention includes: a first driver, a second driver, and a positioning component. The first driver has a driving part on one end and a mounting part on the other end. The mounting part has an opening end. An accommodating space is formed from the opening end toward the driving part. The second driver has a connecting holder at the end corresponding to the opening end of the mounting part of the first driver. The connecting holder connects to and slides in the accommodating space of the first driver. The other end of the second driver has another driving part. The driving parts of the drivers are disposed in opposite directions. The positioning component is interposed between the mounting part of the first driver and the connecting holder of the second driver, for the first driver and the second driver to connect and position with each other.

Besides, one end of the driving part of the first driver is provided with a pivotal connecting part. The mounting part of the first driver is protruded with a connecting element from the end surface corresponding to the pivotal connecting part in order to be pivotally positioned inside the pivotal connecting part of the driving part. A positioning element is used to fix the pivotal connection. The driving part of the second driver also has a pivotal connecting part on one of its end surfaces. The connecting holder of the second driver is protruded with a connecting element from the end surface corresponding to the pivotal connecting part in order to be pivotally positioned in the pivotal connecting part. A positioning element is used to fix the pivotal connection.

### BRIEF DESCRIPTION OF THE DRAWINGS

The invention will become more fully understood from the detailed description given herein below illustration only, and thus is not limitative of the present invention, and wherein:

FIG. 1 is a three-dimensional exploded view of the invention;

FIG. 2 is an exploded cross-sectional view of the invention;

FIG. 3 is an assembled cross-sectional view of the invention;

FIG. 4 is a local cross-sectional view of the second embodiment of the invention;

FIG. 5 is a local cross-sectional view of the third embodiment of the invention;

FIG. 6 is a local cross-sectional view of the fourth embodiment of the invention;

FIG. 6A is a locally enlarged view of FIG. 6;

FIG. 7 is a local cross-sectional view of the fifth embodiment of the invention;

FIG. 8 is a three-dimensional exploded view of the sixth embodiment of the invention;

FIG. 9 is a three-dimensional exploded view of a conventional wrench; and

FIG. 10 is the cross-sectional view of another conventional wrench.

### DETAILED DESCRIPTION OF THE INVENTION

The present invention will be apparent from the following detailed description, which proceeds with reference to the accompanying drawings, wherein the same references relate to the same elements.

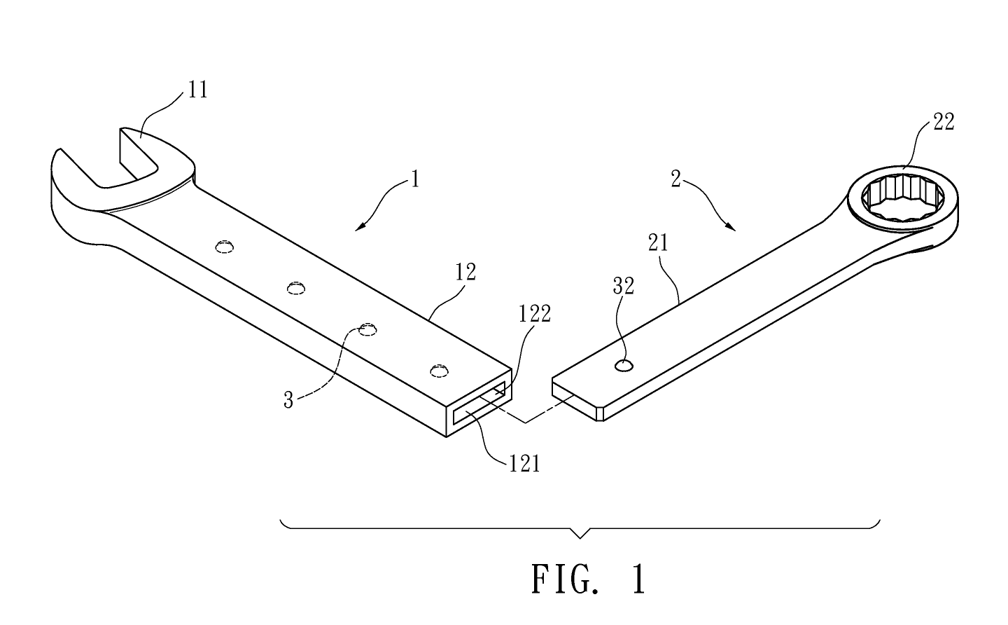

Please refer to FIGS. 1 to 8 for embodiments of the invention. They are used for the purpose of explanation. The scope of the invention is not restricted to these possibilities.

As shown in FIG. 1, the disclosed retractable wrench includes: a first driver 1, a second driver, 2, and a positioning component 3.

The first driver 1 has a driving part 11 on its one end for driving an object (not shown) and a mounting part 12 on the other end. The mounting part 12 has an opening end 121 with an accommodating space 122 toward the driving part 11.

The second driver 2 has a connecting handle 21 on the end corresponding to the opening end 121 of the mounting part 12 of the first driver 1. The connecting handle 21 connects to and slides in the accommodating space 122 of the first driver 1. The other end is provided with another driving part 22 for driving an object (not shown). The driving parts 11, 22 of the drivers 1, 2 are disposed in opposite directions.

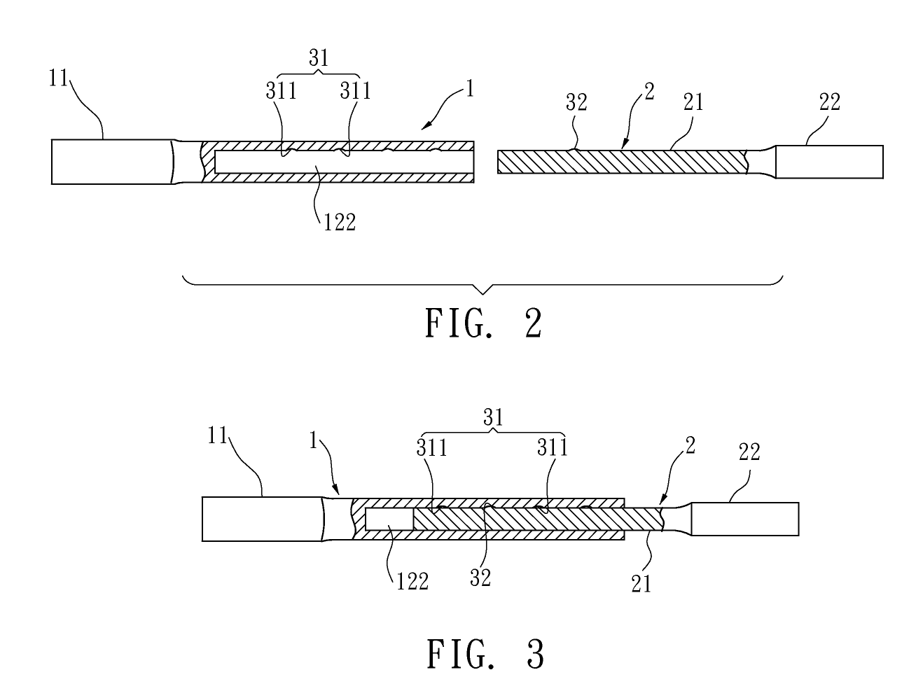

The positioning component 3 is interposed between the mounting part 12 of the first driver 1 and the connecting handle 21 of the second driver 2 for the first driver 1 and the second driver 2 to connect and position. Please refer to FIGS. 2 and 3. The positioning component 3 consists of a positioning part 31 disposed in the accommodating space 122 of the mounting part 12 of the first driver 1 and a fixing part 32 disposed in the connecting handle 21 of the second driver 2.

In this embodiment, the positioning part 31 is located on one side in the accommodating space 122 and consists of several equally spaced grooves 311. The fixing part 32 is a protruding block corresponding to the grooves 311 of the positioning part 31. The fixing part 32 can be fixed in one of the grooves 311 of the positioning part 31 of the first driver 1.

When a user adjusts the overall length of the wrench, he can first hold the first driver 1 to fix it. The second driver 2 is then slid along the accommodating space 122 of the mounting part 12 of the first driver 1 due to the connecting handle 21. At the same time, the fixing part 32 of the connecting handle 21 is selectively fixed in any groove 311 of the positioning part 31 inside the accommodating space 122. The wrench is thus positioned after it is retracted to a desired length.

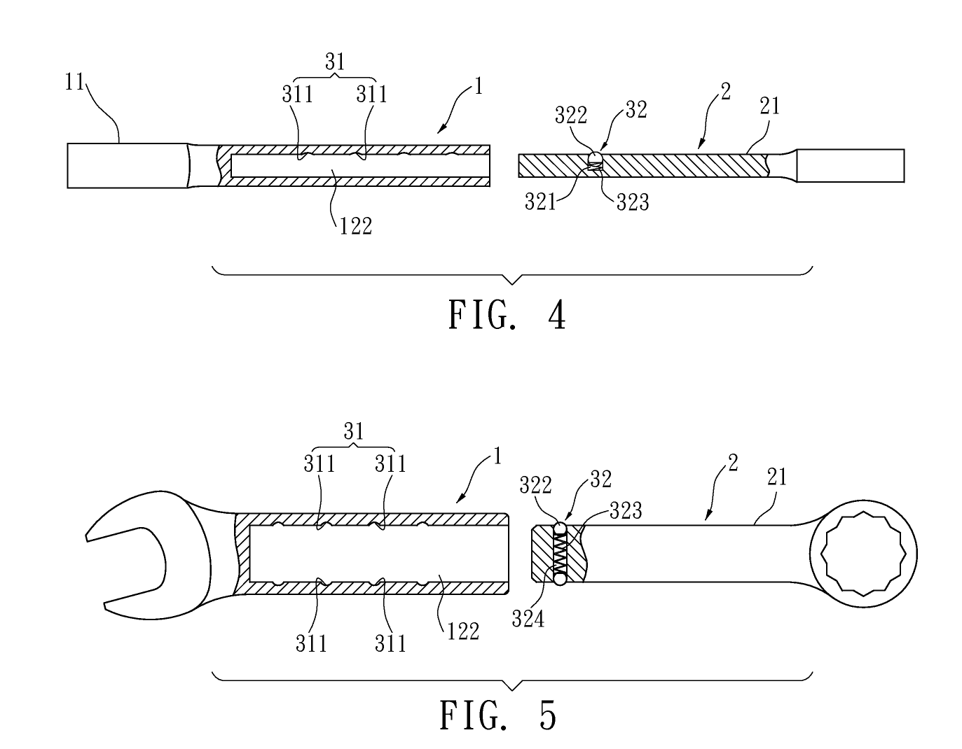

Of course, the invention has many other embodiments that only differ in minor details. Please refer to FIG. 4 for a second embodiment of the invention. It differs from the first embodiment in that the positioning part 32 of the positioning component 3 has a cavity 321, a steel ball 322, and a spring 323. They are used to fix the positioning part 32 in any groove 311 of the positioning part 31 of the first driver 1. One end of the spring 323 urges against the cavity 321, and the other end against the steel ball 322.

Please refer to FIG. 5 for a third embodiment of the invention. It differs from the first embodiment in that the positioning part 31 is located on two opposite sides in the accommodating space 122. It has several equally spaced grooves 311. The fixing part 32 of the second driver 2 has a through hole 324, a spring 323, and two steel balls 322.

The through hole 324 goes through the connecting handle 21, with its both ends corresponding to the grooves 311 on both sides of the accommodating space 122. The spring 323 is accommodated in the through hole 324. The steel balls 322 are on both ends of the spring 323, so that each of them is urged to be fixed in a corresponding groove 311 of the positioning part 31 in the accommodating space 122 of the first driver 1.

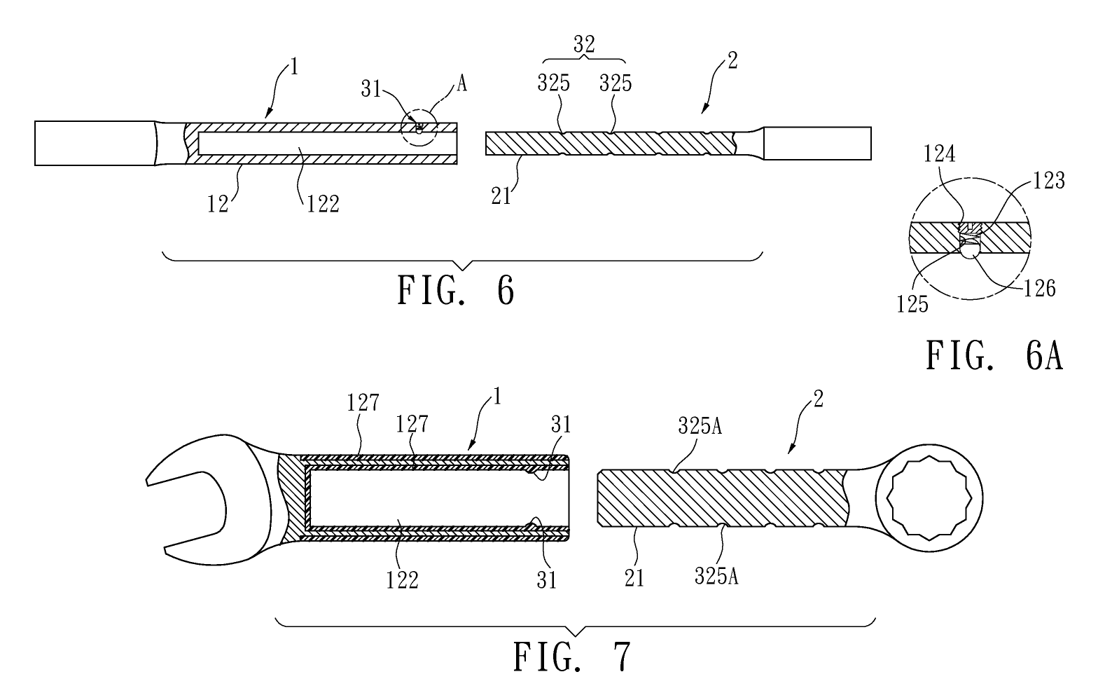

Please refer to FIGS. 6 and 6A for a fourth embodiment of the invention. It differs from the first embodiment in that the positioning part 31 includes a through hole 123, a blocker 124, a spring 125, and a steel ball 126.

The through hole 123 goes from the accommodating space 122 through the surface of the mounting part 12 of the first driver 1. The blocker 124 is disposed at the end of the through hole near the surface. The spring 125 is accommodated in the through hole 123 and urges against the blocker 124 using its one end. The other end of the spring 125 urges against the steel ball 126. The fixing part 32 is disposed on the side of the connecting handle 21 of the second driver 2 corresponding to the positioning part 31. It consists of several equally spaced grooves 325 for the steel ball 126 of the positioning part 31 to be fixed in one of them.

FIG. 7 shows a fifth embodiment of the invention. An anti-skid layer 127 is disposed on the surface of the first driver 1 and inside the accommodating space 122, respectively. The anti-skid layer 127 and the first driver 1 are of different materials. In this embodiment, the first driver 1 is a metal, and the anti-skid layer a rubber or plastic material. The positioning part 31 is disposed on two opposite sides of the anti-skid layer 127 in the accommodating space 122. The positioning part 31 includes two corresponding protruding blocks. The fixing part 32 includes several equally spaced grooves 325A on the connecting handle 21 of the second driver 2 corresponding to the positioning part 31. Each of the grooves 325A of the fixing part 32 can fix the positioning part 31 of the anti-skid layer 127 in the accommodating space 122 of the first driver 1.

With this structure, the anti-skid layer 127 on the surface of the first driver 1 provides a better grip for the user. The anti-skid layer 127 in the accommodating space 122 of the first driver 1 enhances the positioning of the connecting handle 21 of the second driver 2 in the accommodating space 122 of the first driver 1.

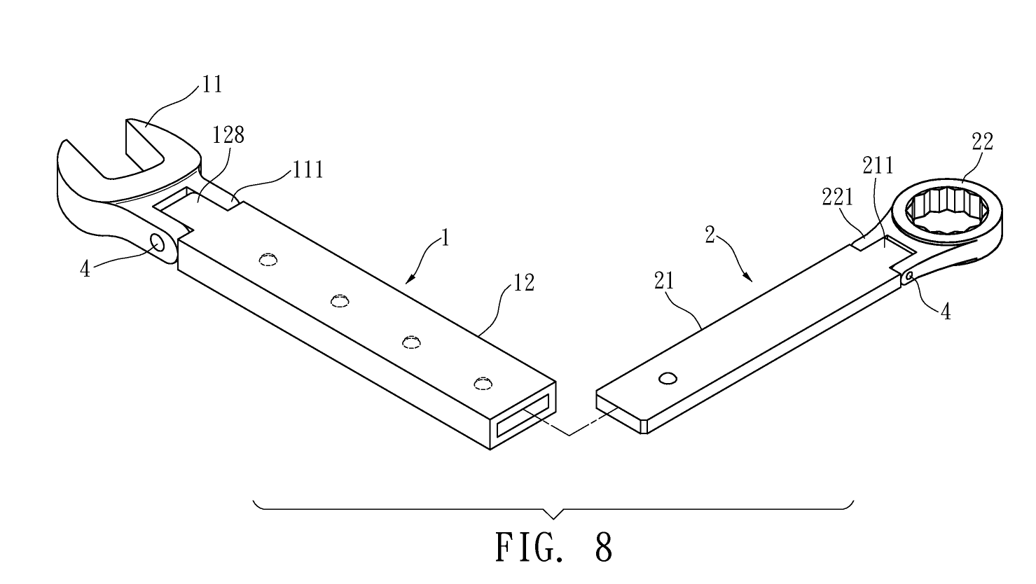

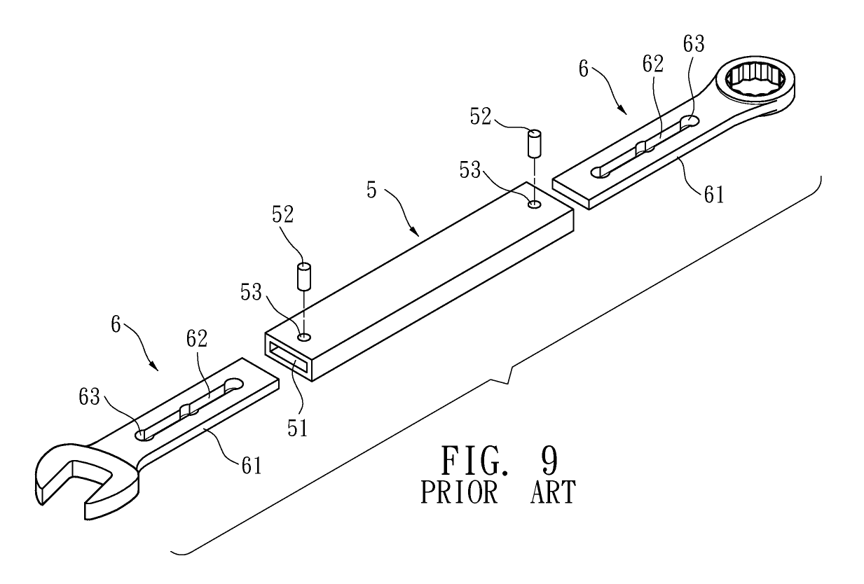

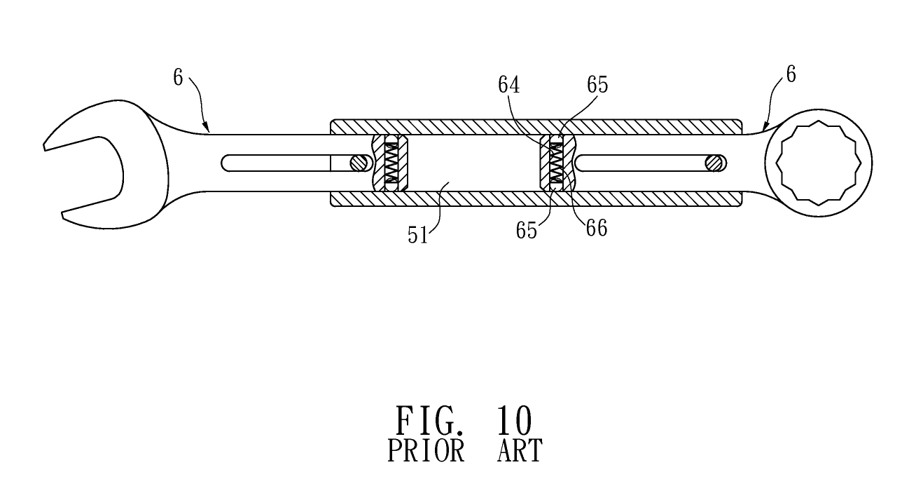

The above-mentioned embodiments are different examples of connecting the first driver 1 and the second driver 2. Please refer to FIG. 8 for a sixth embodiment of the invention. One end surface of the driving part 11 of the first driver 1 can be provided with a pivotal connecting part 111. The end surface of the mounting part 12 of the first driver 1 corresponding to the pivotal connecting part 111 is protruded with a connecting element 128 for a pivotal connection in the pivotal connecting part 111 of the driving part 11. A positioning element 4 is used in the pivotal connection. One end surface of the driving part 22 of the second driver 2 is also provided with a pivotal connecting part 221. The end surface of the connecting handle 21 of the second driver 2 corresponding to the pivotal connecting part 221 is protruded with a connecting element 211 for a pivotal connection in the pivotal connecting part 221. A positioning element 4 is used in the pivotal connection. Each of the pivotal connecting parts 111, 221 can be a groove or ridge structure. Each of the connecting elements 128, 211 can be a groove or ridge structure as well.

In summary, the invention involves simple structures. It has only a first driver and a second driver to form a wrench. The first driver 1 has an accommodating space 122 for the connecting handle 21 of the second driver 2 to slide therein and be positioned. This greatly reduces the number of components in the structure and thus the production cost. The strength of each of the connecting handles 12, 21 of the drivers 1, 2 is also sufficient good for the safety of the user.

Moreover, the anti-skid layer 127 on the surface of the first driver 1 provides a better grip for the user. The anti-skid layer 127 in the accommodating space 122 of the first driver 1 can enhance the positioning of the connecting handle 21 of the second driver 2 therein.

Although the invention has been described with reference to specific embodiments, this description is not meant to be construed in a limiting sense. Various modifications of the disclosed embodiments, as well as alternative embodiments, will be apparent to people skilled in the art. Therefore, it is contemplated that the appended claims will cover all modifications that fall within the true scope of the invention.

1-10. (canceled)

11. A wrench comprising:
a first driver comprising:
a driving part;
a connecting handle connected to the driving part of the first driver; and
a accommodating space in the connecting handle of the first driver;
a second driver comprising:
a connecting handle received in the accommodating space of the first driver and moveable relative to the accommodating space of the first driver; and
a driving part connected to the connecting handle of the second driver, wherein the driving part of the first driver and the driving part of the second driver are located at opposite ends of the combination of the first driver and the second driver; and
a positioning component for holding the connecting handle of the second driver in a temporarily fixed position relative to the accommodating space of the first driver.

12. The wrench of claim 11, wherein the positioning component comprises:
at least one groove located in the connecting handle of the first driver; and
at least one protruding block located on the connecting handle of the second driver and engaging the groove.

13. The wrench of claim 11, wherein the positioning component comprises:
a plurality of grooves located in the connecting handle of the first driver; and
at least one protruding block located on the connecting handle of the second driver and engaging one of the grooves.

14. The wrench of claim 11, wherein the positioning component comprises:
a plurality of equal spaced grooves located in the connecting handle of the first driver; and
at least one protruding block located on the connecting handle of the second driver and engaging one of the grooves.

15. The wrench of claim 11, wherein the positioning component comprises:
a plurality of grooves located in the connecting handle of the first driver;
at least one cavity located in the connecting handle of the second driver;
at least one ball engaging one of the grooves; and
at least one spring received in the cavity and pushing against the ball.

16. The wrench of claim 11, wherein the positioning component comprises:
a plurality of grooves located in the connecting handle of the first driver;
at least one through hole located in the connecting handle of the second driver;
at least two balls each engaging one of the grooves; and
at least one spring received in the through hole, wherein the balls are connected to opposite ends of the spring.

17. The wrench of claim 11, wherein the positioning component comprises:
a plurality of grooves located in the connecting handle of the second driver;
at least one protruding block located on the surface of the accommodating space of the first driver and engaging one of the grooves.

18. The wrench of claim 11, wherein the positioning component comprises:
a plurality of grooves located in the connecting handle of the second driver;
at least one cavity located in the connecting handle of the first driver;
at least one ball engaging one of the grooves; and
at least one spring received in the cavity and pushing against the ball.

19. The wrench of claim 11, further comprising:
an anti-skid layer disposed on the surface of the connecting handle of the first driver.

20. The wrench of claim 11, further comprising:
an anti-skid layer disposed on the surface of the accommodating space of the first driver.

21. The wrench of claim 11, wherein the first driver comprises:
a pivotal connecting part connecting the driving part of the first driver to the connecting handle of the first driver.

22. The wrench of claim 11, wherein the second driver comprises:
a pivotal connecting part connecting the driving part of the second driver to the connecting handle of the second driver.

23. A wrench comprising:
a first driver comprising:
a driving part; and
a connecting handle connected to the driving part of the first driver;
a second driver comprising:
a connecting handle telescopically received in the connecting handle of the first driver; and
a driving part connected to the connecting handle of the second driver, wherein the driving part of the first driver and the driving part of the second driver are located at opposite ends of the combination of the first driver and the second driver; and
a positioning component for holding the connecting handle of the second driver in a temporarily fixed position relative to the connecting handle of the first driver.

24. The wrench of claim 23, wherein the positioning component comprises:
at least one groove located in the connecting handle of the first driver; and
at least one protruding block located on the connecting handle of the second driver and engaging the groove.

25. The wrench of claim 23, wherein the positioning component comprises:
a plurality of grooves located in the connecting handle of the first driver; and
at least one protruding block located on the connecting handle of the second driver and engaging one of the grooves.

26. The wrench of claim 23, wherein the positioning component comprises:
a plurality of grooves located in the connecting handle of the first driver;
at least one cavity located in the connecting handle of the second driver;
at least one ball engaging one of the grooves; and
at least one spring received in the cavity and pushing against the ball.

27. The wrench of claim 23, wherein the positioning component comprises:
a plurality of grooves located in the connecting handle of the first driver;
at least one through hole located in the connecting handle of the second driver;
at least two balls each engaging one of the grooves; and
at least one spring received in the through hole, wherein the balls are connected to opposite ends of the spring.

28. The wrench of claim 23, wherein the positioning component comprises:
a plurality of grooves located in the connecting handle of the second driver;
at least one protruding block located on the connecting handle of the first driver and engaging one of the grooves.

29. The wrench of claim 23, wherein the positioning component comprises:
a plurality of grooves located in the connecting handle of the second driver;
at least one cavity located in the connecting handle of the first driver;
at least one ball engaging one of the grooves; and
at least one spring received in the cavity and pushing against the ball.

30. A wrench comprising:
a first driver comprising:
a driving part; and
a connecting handle connected to the driving part of the first driver;
a second driver comprising:
a connecting handle telescopically received in the connecting handle of the first driver; and
a driving part connected to the connecting handle of the second driver, wherein the driving part of the first driver and the driving part of the second driver are located at opposite ends of the combination of the first driver and the second driver; and
means for holding the connecting handle of the second driver in a temporarily fixed position relative to the connecting handle of the first driver.
